(19) United States
(12) Patent Application Publication
(10) Pub. No.: US 2017/0017124 A1
(43) Pub. Date: Jan. 19, 2017

(54) PHOTOLUMINESCENT DISPLAY DEVICE

(71) Applicant: Samsung Display Co., LTD., Yongin-si (KR)

(72) Inventors: Donghoon KIM, Suwon-si (KR); Youra KIM, Seoul (KR); Young-min PARK, Hwaseong-si (KR); Junwoo YOU, Seongnam-si (KR); Seunghwan CHUNG, Seongnam-si (KR)

(21) Appl. No.: 15/093,065

(22) Filed: Apr. 7, 2016

(30) Foreign Application Priority Data
Jul. 13, 2015 (KR) 10-2015-0099368

(51) Int. Cl. G02F 1/1335; F21V 8/00

(52) U.S. Cl. CPC G02F 1/133621; G02B 6/0051; G02B 6/0053; G02F 1/133528; G02F 2001/133614

(57) ABSTRACT

A photoluminescent display device includes a backlight unit, an optical sheet provided on the backlight unit, and a display panel provided on the optical sheet where the display panel includes a first substrate, a first polarizing plate provided on the first substrate, and a color conversion layer provided on the first polarizing plate and including a photoexcitation member, the optical sheet includes a plurality of first optical parts and a plurality of second optical parts, each of the first optical parts has a first refractive index, and the second optical parts are provided alternately with the first optical parts in a plan view and each of the second optical parts has a second refractive index greater than the first refractive index.

This U.S. application claims priority to Korean Patent Application No. 10-2015-0099368, filed on Jul. 13, 2015, and all the benefits accruing therefrom under 35 U.S.C. §119, the content of which in its entirety is herein incorporated by reference.

### BACKGROUND

1. Field

Exemplary embodiments of the invention herein relate to a photoluminescent display device, and particularly to, a photoluminescent display device capable of improving display quality.

2. Description of the Related Art

In general, photoluminescent display devices are display devices in which a photoexcitation member replaces a color filter used for typical photoluminescent devices. The photoluminescent display device displays an image using the visible light generated when the light in a low wavelength band, which is generated from a light source and controlled by a liquid crystal layer, is provided to a color conversion layer.

### SUMMARY

Exemplary embodiments of the invention provide a photoluminescent display device with improved display quality.

An exemplary embodiment of the invention provides a photoluminescent display device including a backlight unit, an optical sheet, and a display panel. The optical sheet is provided on the backlight unit. The display panel is provided on the optical sheet. The display panel includes a first substrate, a first polarizing plate provided on the first substrate, and a color conversion layer provided on the first polarizing plate and having a photoexcitation member. The optical sheet includes a plurality of first optical parts and a plurality of second optical parts. Each of the first optical parts has a first refractive index. The second optical parts are provided alternately with the first optical parts in a plan view and each of the second optical parts has a second refractive index greater than the first refractive index.

In an exemplary embodiment, each of the first optical parts may include at least one of acryl-based resin, fluorine-based resin, silicon-based resin, polycarbonate-based resin, polyamide-based resin, polystyrene-based resin, polyvinylchloride-based resin, polyester-based resin, polyolefin-based resin, polyethylene-based resin, polypropylene-based resin and polybutylene-based resin.

In an exemplary embodiment, each of the second optical parts may include at least one of carbon black, iron oxide, chromium oxide, zirconium oxide, zinc or cerium oxide, manganese violet, blue ultramarine, chromium hydrate, and iron blue.

In an exemplary embodiment, in the plan view, each of the first optical parts may have at least one shape of rectangular, square, circular, and elliptical shapes.

In an exemplary embodiment, in the plan view, the first optical parts may extend in a first direction and to be spaced apart from each other in a second direction crossing the first direction.

In an exemplary embodiment, spacing distances between the first optical parts may be constant in the plan view.

In an exemplary embodiment, in the plan view, the first optical parts may be spaced apart from each other in a first direction and in a second direction crossing the first direction.

In an exemplary embodiment, in a cross-section, a width of each of the first optical parts may become greater as the first optical parts are closer to the backlight unit than to the display panel.

In an exemplary embodiment, in a cross-section, a width of each of the first optical parts may be predetermined.

In an exemplary embodiment, in a cross section, a sum of areas of the first optical parts may be greater than a sum of areas of the second optical parts.

In an exemplary embodiment, in a cross-section, each of the first optical parts may have a trapezoidal shape, and each of the second optical parts may have an inverted triangular shape.

In an exemplary embodiment, in a cross-section, each of the first and second optical parts may have a rectangular shape.

In an exemplary embodiment, a thickness of each of the first optical parts may be the same as a thickness of each of the second optical parts.

In an exemplary embodiment, the optical sheet may further include third optical parts which are provided on at least a portion of the second optical parts, and each of which has the second refractive index and a small third refractive index.

In an exemplary embodiment, a photoluminescent display device may further include a reverse prism sheet provided between the backlight unit and the optical sheet.

In an exemplary embodiment, the display panel may further include a plurality of pixels, the pixels overlapping the first optical parts.

In an exemplary embodiment, the backlight unit may emit blue light.

### BRIEF DESCRIPTION OF THE DRAWINGS

The accompanying drawings are included to provide a further understanding of the invention, and are incorporated in and constitute a part of this specification. The drawings illustrate exemplary embodiments of the invention and, together with the description, serve to explain principles of the invention. In the drawings:

FIG. 1 is a schematic exploded perspective view illustrating an exemplary embodiment of a photoluminescent display device according to the invention;

FIG. 2 is a schematic plan view illustrating an exemplary embodiment of one of pixels included in a luminescent display device according to the invention;

FIG. 3A is a schematic cross-sectional view of a display panel taken along line I-I′ of FIG. 2;

FIG. 3B is a schematic cross-sectional view of a display panel taken along line II-II′ of FIG. 2;

FIG. 3C is a schematic cross-sectional view of a display panel taken along line III-III′ of FIG. 2;

FIGS. 4A, 4B, and 4C are schematic plan views of an exemplary embodiment of optical sheets included in photoluminescent display devices according to the invention;

FIGS. 5A and 5B are schematic cross-sectional views of an exemplary embodiment of optical sheets included in photoluminescent display devices according to the invention;

FIGS. 6A and 6B are schematic cross-sectional views of an exemplary embodiment of optical sheets included in photoluminescent display devices according to the invention; and

FIG. 7 is a schematic exploded perspective view illustrating an exemplary embodiment of a display panel and an optical sheet included in a photoluminescent display device according to the invention.

### DETAILED DESCRIPTION

The objects, other objectives, features, and advantages of the invention will be understood without difficulties through preferred embodiments below related to the accompanying drawings. The invention may, however, be embodied in different forms and should not be construed as limited to the embodiments set forth herein. Rather, these embodiments are provided so that this invention will be thorough and complete, and will fully convey the scope of the invention to those skilled in the art.

Like reference numerals refer to like elements throughout. In the drawings, the dimensions and size of each structure are exaggerated, omitted, or schematically illustrated for convenience in description and clarity. It will be understood that although the terms of first and second are used herein to describe various elements, these elements should not be limited by these terms. Terms are only used to distinguish one component from other components. For example, a first element referred to as a first element in one embodiment can be referred to as a second element in another embodiment. The terms of a singular form may include plural forms unless referred to the contrary.

In the specification, the meaning of ‘include’ or ‘comprise’ specifies a property, a numeral, a step, an operation, an element or a combination thereof, but does not exclude other properties, numerals, steps, operations, elements or combinations thereof. In addition, it will be understood that when a layer, a film, a region, or a plate is referred to as being ‘on’ another layer, region, film, or plate, it can be directly on the other layer, film, region, or plate, or intervening layers, films, regions, or plates may also be present. On the contrary, it will be understood that when a layer, a film, a region, or a plate is referred to as being ‘under’ another layer, region, or plate, it can be directly under the other layer, film, region, or plate, or intervening layers, films, regions, or plates may also be present.

It will be understood that, although the terms “first,” “second,” “third” etc. may be used herein to describe various elements, components, regions, layers and/or sections, these elements, components, regions, layers and/or sections should not be limited by these terms. These terms are only used to distinguish one element, component, region, layer or section from another element, component, region, layer or section. Thus, “a first element,” “component,” “region,” “layer” or “section” discussed below could be termed a second element, component, region, layer or section without departing from the teachings herein.

The terminology used herein is for the purpose of describing particular embodiments only and is not intended to be limiting. As used herein, the singular forms “a,” “an,” and “the” are intended to include the plural forms, including “at least one,” unless the content clearly indicates otherwise. “Or” means “and/or.” As used herein, the term “and/or” includes any and all combinations of one or more of the associated listed items. It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

Furthermore, relative terms, such as “lower” or “bottom” and “upper” or “top,” may be used herein to describe one element's relationship to another element as illustrated in the Figures. It will be understood that relative terms are intended to encompass different orientations of the device in addition to the orientation depicted in the Figures. In an exemplary embodiment, when the device in one of the figures is turned over, elements described as being on the “lower” side of other elements would then be oriented on “upper” sides of the other elements. The exemplary term “lower,” can therefore, encompasses both an orientation of “lower” and “upper,” depending on the particular orientation of the figure. Similarly, when the device in one of the figures is turned over, elements described as “below” or “beneath” other elements would then be oriented “above” the other elements. The exemplary terms “below” or “beneath” can, therefore, encompass both an orientation of above and below.

“About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within ±30%, 20%, 10%, 5% of the stated value.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and the invention, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. In an exemplary embodiment, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the claims.

Hereinafter, a photoluminescent display device according to an exemplary embodiment of the invention will be described.

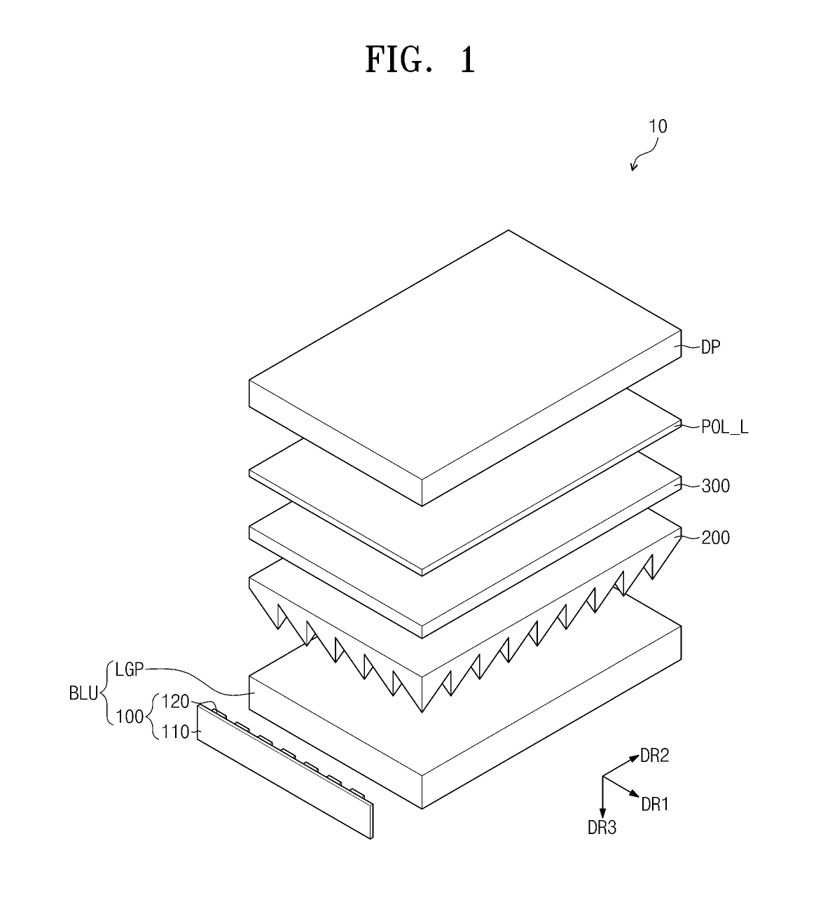

FIG. 1 is a schematic exploded perspective view illustrating a photoluminescent display device according to an exemplary embodiment of the invention.

Referring to FIG. 1, a photoluminescent display device 10 according to an exemplary embodiment of the invention includes a backlight unit BLU, an optical sheet 300, and a display panel DP.

The backlight unit BLU emits light having a certain wavelength band. In an exemplary embodiment, the backlight unit BLU may emit blue light, for example. In an exemplary embodiment, the backlight unit BLU may emit light having a wavelength band of about 200 nm to 400 nm, for example. However, the invention is not limited thereto, and the backlight unit BLU may emit ultraviolet (“UV”) light, for example.

The backlight unit BLU includes a light source unit 100 and a light guide plate LGP. The light source unit 100 provides light. The light source unit 100 may include at least one light source 120 and a circuit board 110 which includes the light source 120 installed on one surface thereof and applies power to the light source 120. The light source 120 may be a light emitting diode (“LED”). The circuit board 110 may have a rectangular shape when viewed from a thickness direction DR3 of the photoluminescent display device 10. The light source 120 may be provided in plurality, and the plurality of light sources 120 may be disposed to be spaced apart from each other in a first direction DR1 on the circuit board 110.

In the photoluminescent display device 10 according to an exemplary embodiment of the invention, it is described as an example that the light source unit 100 is provided corresponding to only one of side surfaces of the light guide plate LGP, but the invention is not limited thereto. In an alternative exemplary embodiment, a plurality of light source units 100 may be disposed along other side surfaces of the light guide plate LGP. In an exemplary embodiment of the invention, although it is described as an example that the photoluminescent display device 10 includes the edge-type light source unit 100, the invention is not limited thereto, and the photoluminescent display device 10 according to an exemplary embodiment of the invention may include a direct-type light source unit.

The light guide plate LGP may be provided under the display panel DP. The light guide plate LGP guides and emits the light provided from the light source 100. The light guide plate LGP guides the light provided from the light source unit 100 toward the display panel DP. The light which enters the light guide plate LGP is emitted toward the display panel DP through a light-emitting surface of the light guide plate LGP.

In an exemplary embodiment, the light guide plate LGP may include, although not particularly limited to as long as being used typically, a transparent polymer resin such as polycarbonate or polymethyl methacrylate.

Although not shown, an optical member may be provided between the display panel DP and the light guide plate LGP. The optical member improves the brightness and viewing angle of the light emitted from the light-emitting surface of the light guide plate LGP. The optical member may include a first optical member, a second optical member and a third optical member, which are sequentially stacked.

The first optical member may be a diffusion sheet diffusing the light emitted from the light guide plate LGP. The second optical member may be a prism sheet collecting the light diffused from the diffusion sheet in a direction perpendicular to a plane of the display panel DP located thereabove. The third optical member may be a protective sheet protecting the prism sheet from external shock. The optical member may be used in such a way that at least one of the first to third optical members are stacked in plurality, and when necessary, one or more sheets may not be provided.

Although not shown, the backlight unit BLU may further include a reflective sheet. The reflective sheet may be provided under the light guide plate LGP. The reflective sheet reflects the light, which does not progress toward the display panel DP but leaks, to change the path of the light to allow the light to progress toward the display panel DP. Accordingly, the reflective sheet increases the amount of the light provided to the display panel DP.

The photoluminescent display device 10 according to an exemplary embodiment of the invention may further include a second polarizing plate POL_L. The second polarizing plate POL_L is provided on the optical sheet 300. The light provided from the optical sheet 300 is polarized while passing through the second polarizing plate POL_L. The polarized light is provided to the display panel DP.

The photoluminescent display device 10 according to an exemplary embodiment of the invention may further include a reverse prism sheet 200. The reverse prism sheet 200 may be provided between the backlight unit BLU and the optical sheet 300. In FIG. 1, although it is illustrated as an example that the reverse prism sheet 200 and the optical sheet 300 are separately provided, the invention is not limited thereto. In an alternative exemplary embodiment, the reverse prism sheet 200 and the optical sheet 300 may be unitary.

Although not shown, the photoluminescent display device 10 according to an exemplary embodiment of the invention may further include a bottom chassis. The bottom chassis may be disposed under the backlight unit BLU. The bottom chassis may accommodate components of the backlight unit BLU, the reverse prism sheet 200, the optical sheet 300, the second polarizing plate POL_L, and the display panel DP.

Although not shown, the photoluminescent display device 10 according to an exemplary embodiment of the invention may further include a mold frame. The mold frame may be provided between the display panel DP and the backlight unit BLU. The mold frame may be provided along the edge of the display panel DP and support the display panel DP under the display panel DP.

The display panel DP is provided over the optical sheet 300. Unlike a self-emissive display panel such as an organic light emitting display panel, the display panel DP may be a non-emissive display panel requiring a separate backlight unit BLU. In an exemplary embodiment, various display panels such as liquid crystal display (“LCD”) panels or electrophoretic display (“EDP”) panel may be used. Hereinafter, it will be described as an example that the display panel DP is an LCD panel.

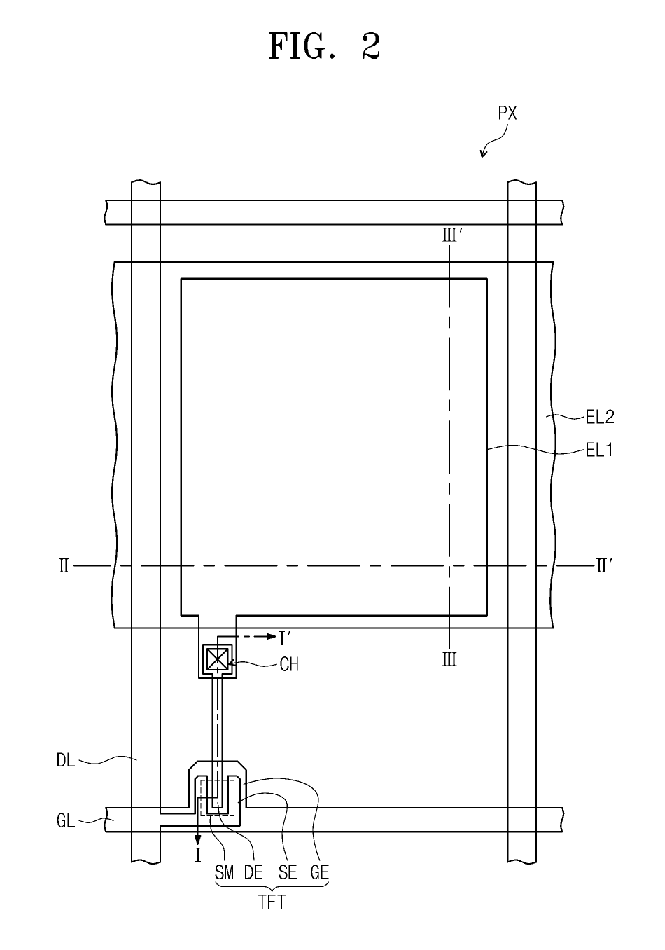

FIG. 2 is a schematic plan view illustrating one of pixels included in a photoluminescent display device according to an exemplary embodiment of the invention. In an exemplary embodiment of the invention, it is illustrated as an example that one pixel is connected to one gate line and one data line, but the invention is not limited thereto. In an alternative exemplary embodiment, a plurality of pixels PX may be connected to one gate line and one data line. Also, one pixel may also be connected to at least one gate line and at least one data line.

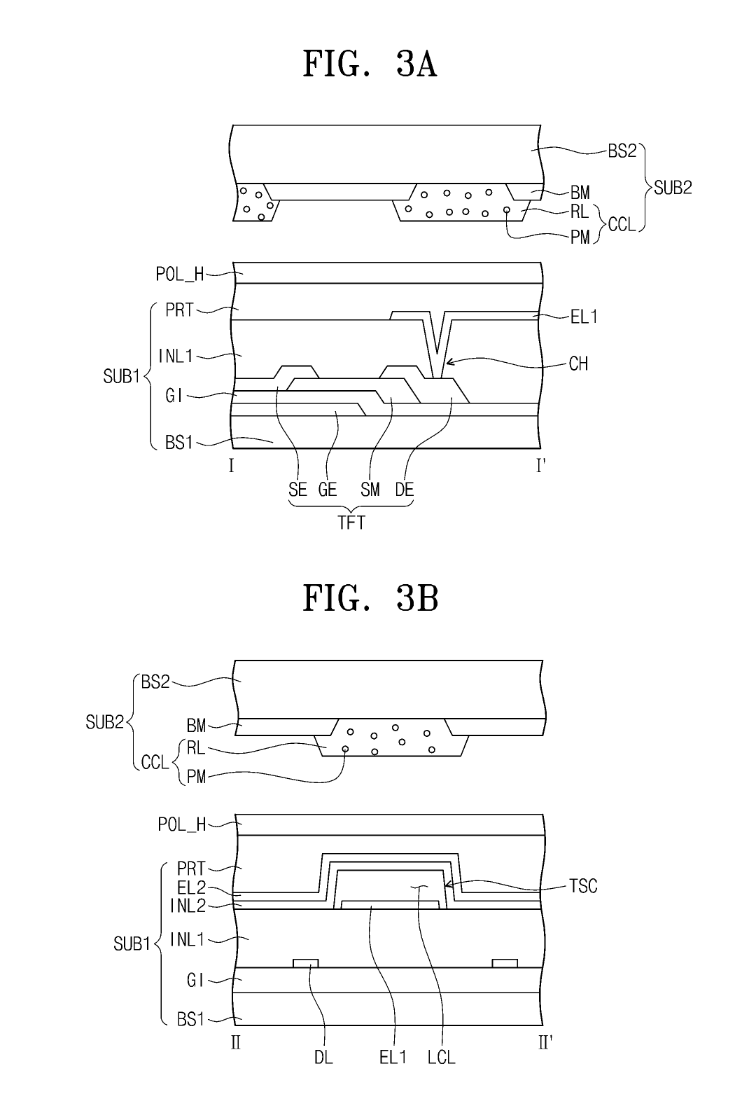

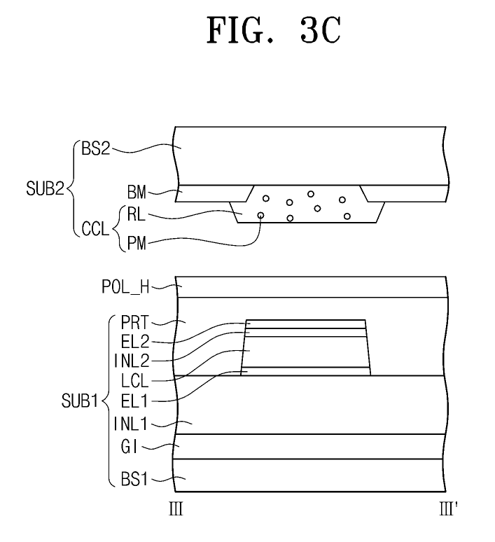

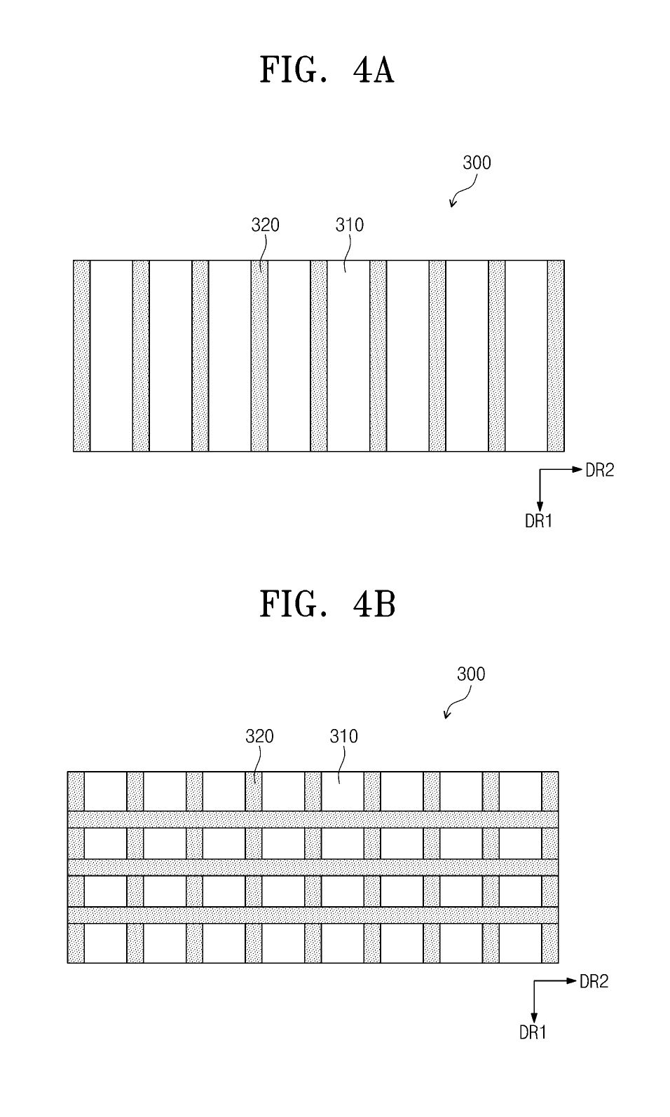

FIG. 3A is a schematic cross-sectional view of a display panel taken along line I-I′ of FIG. 2. FIG. 3B is a schematic cross-sectional view of a display panel taken along line II-II′ of FIG. 2. FIG. 3C is a schematic cross-sectional view of a display panel taken along line III-III′ of FIG. 2.

Referring to FIGS. 1, 2, 3A, and 3C, the display panel DP includes a first substrate SUB1, a first polarizing plate POL_H, and a second substrate SUB2.

The first substrate SUB1 includes a first base substrate BS1, a plurality of gate lines GL, a plurality of data lines DL, and a plurality of pixels PX. Each of the pixels PX may include a thin film transistor TFT, a first electrode EL1, and a second electrode EL2.

In an exemplary embodiment, the first base substrate BS1 may include, although not particularly limited thereto as long as being generally used, glass, plastic, quartz, organic polymer, etc. The organic polymer forming the first base substrate BS1 may include, for example, polyethylene terephthalate (“PET”), polyethylene naphthalate (“PEN”), polyimide, polyether sulfone, and the like. The first base substrate BS1 may be selected in consideration of mechanical strength, thermal stability, transparency, surface smoothness, ease of handling, waterproofing property, etc.

The thin film transistor TFT may be provided on the first base substrate BS1. The thin film transistor TFT may include a gate electrode GE, a semiconductor pattern SM, a source electrode SE, and a drain electrode DE.

The gate electrode GE is branched from the gate line or provided on a portion of the gate line. In an exemplary embodiment, the gate electrode GE may include metal, for example. The gate electrode GE may include a plurality of layers. In an exemplary embodiment, the gate electrode GE may include nickel, chromium, molybdenum, aluminum, titanium, copper, tungsten, or any alloy thereof, for example.

A gate insulation layer GI is provided on the gate electrode GE. The gate insulation layer GI may be provided on an entire surface of the first base substrate BS1 to cover the gate electrode GE. The gate insulation layer GI may be an organic or inorganic layer. The gate insulation layer GI may have a single-layered or multi-layered structure.

The semiconductor pattern SM is provided on the gate insulation layer GI. The semiconductor pattern SM is provided on the gate electrode GE with the gate insulation layer GI disposed therebetween, so that a portion thereof overlaps the gate electrode GE.

The source electrode SE may be branched from the data line. The source electrode SE partially overlaps the gate electrode GE. The drain electrode DE is spaced apart from the source electrode SE with the semiconductor pattern SM disposed therebetween. The drain electrode DE is provided such that a portion thereof overlaps the gate electrode GE.

The source electrode SE and the drain electrode DE each may have a multilayered structure. In an exemplary embodiment, each of the source electrode SE and the drain electrode DE may include nickel, chromium, molybdenum, aluminum, titanium, copper, tungsten, or any alloy thereof, for example.

A first insulation layer INL1 is provided on the source electrode SE, the drain electrode DE, and the semiconductor pattern SM. The insulation layer INL1 may be provided on an entire surface of the first base substrate BS1 to cover the thin film transistor TFT. The first insulation layer INL1 may be an organic layer or an inorganic layer. The first insulation layer INL1 may have a single-layered or multi-layered structure.

A first electrode EL1 may be provided on the first insulation layer INL1. The first electrode EL1 is connected to the drain electrode DE through a contact hole CH. In an exemplary embodiment, the first electrode EL1 may include, for example, a transparent conductive material. In an exemplary embodiment, the first electrode EL1 may include, for example, transparent conductive oxide. In an exemplary embodiment, the transparent conductive oxide may include, for example, at least one of indium tin oxide (“ITO”), indium zinc oxide (“IZO”), and indium tin zinc oxide (“ITZO”). Although not shown, an insulation layer protecting the first electrode EL1 may be provided on the first electrode Ell. Also, although not shown, an alignment film may be provided on the first electrode Ell.

The second electrode EL2 forms an electric field with the first electrode EL1. The second electrode EL2 overlaps the first electrode EL1 in a plan view. In an exemplary embodiment, the second electrode EL2 may include, for example, a transparent conductive material. In an exemplary embodiment, the second electrode EL2 may include, for example, transparent conductive oxide. In an exemplary embodiment, the transparent conductive oxide may include, for example, at least one of ITO, IZO, and ITZO.

A second insulation layer INL2 protecting the second electrode EL2 is provided on a bottom surface of the second electrode EL2. A tunnel-shaped cavity TSC may be defined by the second insulation layer INL2. Although not shown, the alignment film may be provided on a bottom surface of the second insulation layer INL2.

The tunnel-shaped cavity TSC is provided between the first and second electrodes EL1 and EL2. A liquid crystal layer LCL may be provided in the tunnel-shaped cavity TSC. The liquid crystal layer LCL includes liquid crystal molecules having optical anisotropy. The liquid crystal molecules may be driven by an electric field and transmit or block the light passing through the liquid crystal layer LCL to display an image. Although it is described as an example that the tunnel-shaped cavity TSC is defined in the photoluminescent display device 10 according to an exemplary embodiment of the invention, the invention is not limited thereto. In an alternative exemplary embodiment, the tunnel-shaped cavity TSC is not defined in the photoluminescent display device 10, and the photoluminescent display device 10 may include a liquid crystal layer LCL which is provided as a single layer between the first and second electrodes EL1 and EL2, each of which is flat.

The protective layer PRT may be provided on the second electrode EL2. The protective layer PRT may seal the tunnel-shaped cavity TSC. The protective layer PRT may be an organic or inorganic layer. The protective layer PRT may have a single-layered or multi-layered structure. Although not shown, a separate encapsulation layer may also be disposed on the protective layer PRT.

The first polarizing plate POL_H is provided on the first substrate SUB1. The light provided from the liquid crystal layer LCL is polarized while transmitting the first polarizing plate POL_H. The polarized light is provided to a color conversion layer CCL.

The second substrate SUB2 is provided on the first polarizing plate POL_H. Although not shown, an insulation layer or the like may be provided, or an air layer or a vacuum layer may also be provided without an insulation layer, between the second substrate SUB2 and the first polarizing plate POL_H. The second substrate SUB2 may include the color conversion layer CCL. The second substrate SUB2 may further include a black matrix BM and a second base substrate BS2.

The color conversion layer CCL is provided on the first polarizing plate POL_H. The color conversion layer CCL may overlap the tunnel-shaped cavity TSC. The color conversion layer CCL receives the light passing through the first polarizing plate POL_H and emits visible light with a predetermined color.

The color conversion layer CCL includes a resin layer RL and a photoexcitation member PM included in the resin layer RL. Although not shown, the resin layer RL may further include a scattering member.

The resin layer RL may include, for example, although not particularly limited to as long as being used typically, silicon resin or photoresist resin.

The photoexcitation member PM absorbs light with a predetermined wavelength band to be in an exciting state, and then emits the absorbed light energy while returning to a ground state. The photoexcitation member PM includes a phosphor or a quantum dot. In an exemplary embodiment, the photoexcitation member PM may include at least one of oxynitride, nitride, silicate, aluminated-, scandate-, and oxyfloride-based materials, for example.

When the photoexcitation member PM is a phosphor and includes Si6-zALzOzN8-z (β-SiAlON), (Ba,Sr)2SiO4:Eu, or CaSc20:Ce, the photoexcitation member PM may emit excited light with a green wavelength band. When the photoexcitation member PM is a phosphor and includes CaAlSiN3:Eu, (Sr,Ca)AlSiN3:Eu, or CaAlSi(ON)3:Eu, the photoexcitation member PM may emit excited light with a red wavelength band. When the photoexcitation member PM is a phosphor and includes Y3Al5O12:Ce or Tb3Al5O12:Ce, the photoexcitation member PM may emit excited light with a yellow wavelength band. When blue light is provided from the backlight unit BLU, and the photoexcitation member PM is a phosphor and includes Y3Al5O12:Ce or Tb3Al5O12:Ce, the light emitted from the photoexcitation member PM and the blue light are mixed such that white light may be emitted.

When the photoexcitation member PM is a quantum dot, the photoexcitation member PM may be Group II-VI based quantum dot including CdSe/ZnS, CdSe/CdS/ZnS, ZnSe/ZnS or ZnTe/ZnSe. The photoexcitation member may be a Group III-V based quantum dot including InP/ZnS or a quantum dot including CuInS(2)/ZnS.

When the photoexcitation member PM includes a quantum dot, the wavelength band of the excited light may vary according to the size of the quantum dot. In an exemplary embodiment, the excited light of the quantum dot may be red, green, or blue light according to the size of the quantum dot.

The scattering member (not shown) scatters the excited light emitted from the photoexcitation member PM. In an exemplary embodiment, the scattering member (not shown) may include, for example, titanium oxides or silicon oxides. In an exemplary embodiment, the scattering member (not shown) may include TiO₂ or SiO₂, for example.

The second base substrate BS2 may be provided on the color conversion layer CCL. However, the invention is not limited thereto, and the second base substrate BS2 may not be provided. In an exemplary embodiment, the second base substrate BS2 may include, although not particularly limited thereto as long as being generally used, glass, plastic, quartz, organic polymer, etc., for example. In an exemplary embodiment, the organic polymer forming the second base substrate BS2 may include, for example, PET, PEN, polyimide, and polyether sulfone. The second base substrate BS2 may be selected in consideration of mechanical strength, thermal stability, transparency, surface smoothness, ease of handling, waterproofing property, etc.

The black matrix BM may overlap a portion of the color conversion layer CCL. The black matrix BM may overlap a light-blocking region of the first substrate SUB1. In the light-blocking region, a thin film transistor TFT, gate lines GL, and data lines DL may be disposed.

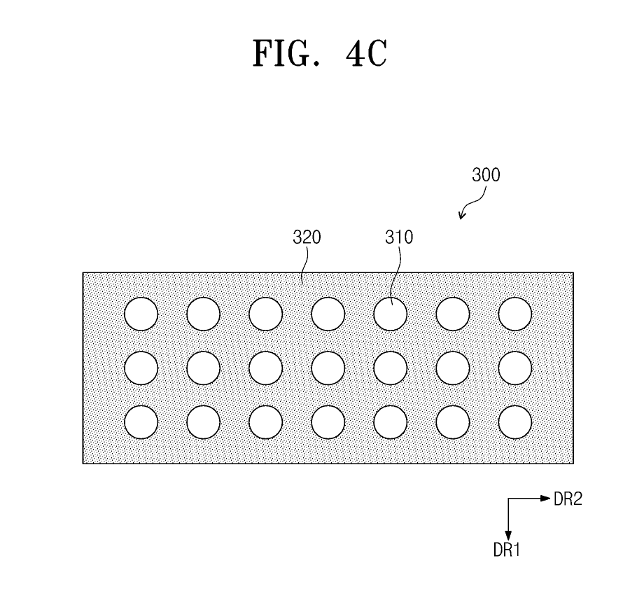

FIGS. 4A, 4B, and 4C are schematic plan views of optical sheets included in photoluminescent display devices according to an exemplary embodiment of the invention.

Referring to FIGS. 4A, 4B, and 4C, in a plan view, each of first optical parts 310 may have at least one shape of a rectangle, a square, a circle, and an ellipse. FIGS. 4A, 4B, and 4C exemplarily illustrate that the respective first optical parts 310 have the same shape and size in a plan view, but the invention is not limited thereto. In an alternative exemplary embodiment, at least one of the shapes of the first optical parts 310 may be different from the others. Also, at least one of the sizes of the shapes of the first optical parts 310 may be different from the others. Second optical parts 320 may have, for example, shapes which are rectangular shapes from which the shapes of the first optical parts 310 are removed. FIGS. 4A and 4B exemplarily illustrate that the respective second optical parts 320 have the same shape and size from a plan view, but the invention is not limited thereto. In an alternative exemplary embodiment, at least one of the shapes of the first optical parts 310 may be different from the others. Also, at least one of the sizes of the shapes of the second optical parts 320 may be different from the others.

Referring to FIG. 4A, in a plan view, the first optical parts 310 may extend in a first direction DR1, and be spaced apart from each other in a second direction DR2 crossing the first direction DR1. Referring to FIGS. 4B and 4C, in a plan view, the first optical parts 310 may be spaced apart from each other in the first direction DR1 and the second direction DR2 crossing the first direction DR1.

Referring back to FIGS. 4A, 4B, and 4C, in a plan view, spacing distances between the first optical parts 310 may be the same. The spacing distance means, for example, the shortest distance between one first optical part 310 and another first optical part 310 most adjacent to the one first optical part 310. FIGS. 4A, 4B, and 4C exemplarily illustrate that the spacing distances between the first optical parts 310 are the same in a plan view, but the invention is not limited thereto. In an alternative exemplary embodiment, at least one of the spacing distances between the first optical parts 310 may be different from the others. In an exemplary embodiment, the first optical parts 310 may be randomly disposed in a plan view.

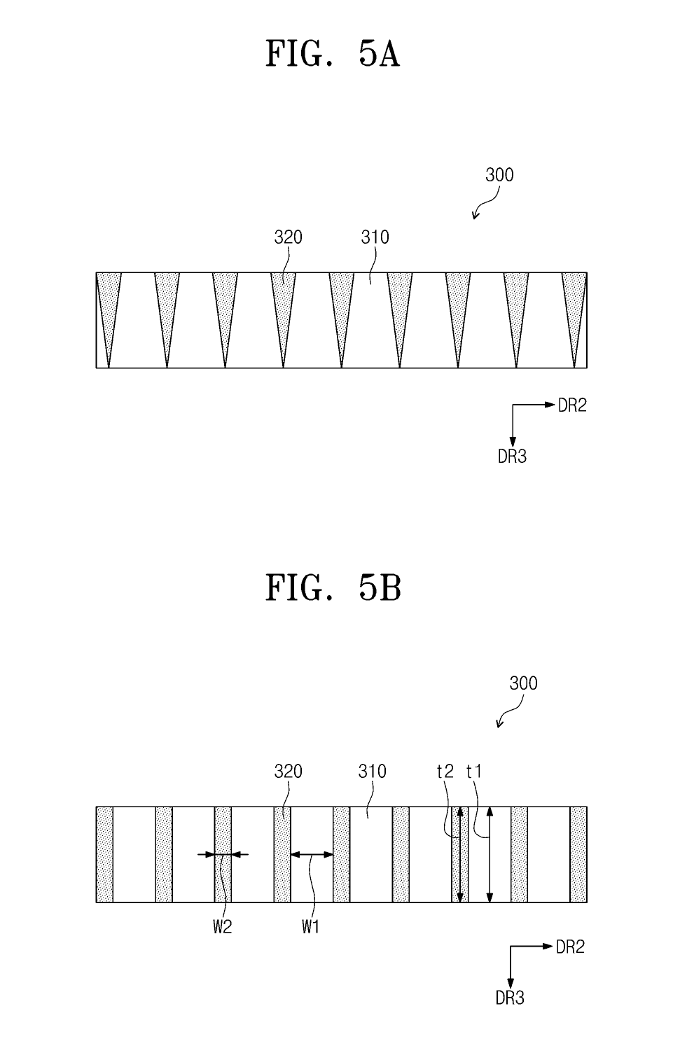

FIGS. 5A and 5B are schematic cross-sectional views of optical sheets included in photoluminescent display devices according to an exemplary embodiment of the invention.

Referring to FIGS. 1, 5A, and 5B, the optical sheet 300 is provided between the display panel DP and the backlight unit BLU. The optical sheet 300 includes a plurality of first optical parts 310 and a plurality of second optical parts 320. Each of the first optical parts 310 has a first refractive index. Each of the second optical parts 320 has a second refractive index greater than the first refractive index. The first optical parts 310 have refractive indices smaller than the second optical parts 320, and thus transmit at least a portion of the light provided from the backlight unit BLU to the display panel DP. The second optical parts 320 have refractive indices greater than the first optical parts 310, and thus reflect at least a portion of the light provided from the backlight unit BLU. At least a portion of the light reflected from the second optical parts 320 may be transmitted to the display panel DP through the first optical parts 310.

In an exemplary embodiment, each of the first optical parts 310 may include, for example, at least one of acryl-based resin, fluorine-based resin, silicon-based resin, polycarbonate-based resin, polyamide-based resin, polystyrene-based resin, polyvinylchloride-based resin, polyester-based resin, polyolefin-based resin, polyethylene-based resin, polypropylene-based resin and polybutylene-based resin.

In an exemplary embodiment, each of the second optical parts 320 may include, for example, at least one of carbon black, iron oxide, chromium oxide, zirconium oxide, zinc or cerium oxide, manganese violet, blue ultramarine, chromium hydrate, and iron blue.

Referring to FIGS. 1 and 5A, in a cross-section, the width of each of the first optical parts 310 may become greater as the first optical parts 310 are closer to the backlight unit BLU than to the display panel DP. The width may mean a length in a direction perpendicular to a thickness direction DR3 of the optical sheet 300. In a cross-section, the first optical parts 310 may have, for example, trapezoidal shapes. FIG. 5A exemplarily illustrates that the respective first optical parts 310 have the same shape and size in a cross-section, but the invention is not limited thereto. In an alternative exemplary embodiment, at least one of the shapes of the first optical parts 310 may be different from the others. Also, at least one of the sizes of the shapes of the first optical parts 310 may be different from the others.

Referring to FIGS. 1 and 5B, in a cross-section, the width W1 of each of the first optical parts 310 may be constant along the third direction DR3. In a cross-section, the first optical parts 310 may have, for example, rectangular shapes. FIG. 5B exemplarily illustrates that the respective first optical parts 310 have the same shape and size in a cross-section, but the invention is not limited thereto. In an alternative exemplary embodiment, at least one of the shapes of the first optical parts 310 may be different from the others. Also, at least one of the sizes of the shapes of the first optical parts 310 may be different from the others.

Referring back to FIGS. 1, 5A, and 5B, in a plan view, the second optical parts 320 may be alternately disposed with the first optical parts 310. Referring to FIGS. 1 and 5A, in a cross-section, the width of each of the second optical parts 320 may become smaller as the second optical parts 320 are closer to the backlight unit BLU than to the display panel DP. In a cross-section, the second optical parts 320 may have, for example, inverted triangular shapes. FIG. 5A exemplarily illustrates that the respective second optical parts 320 have the same shape and size in a cross-section, the invention is not limited thereto. In an alternative exemplary embodiment, at least one of the shapes of the second optical parts 320 may be different from the others. Also, at least one of the sizes of the shapes of the second optical parts 320 may be different from the others.

Referring to FIGS. 1 and 5B, in a cross-section, the width W2 of each of the second optical parts 320 may be constant along the third direction DR3. In a cross-section, the second optical parts 320 may have, for example, rectangular shapes. FIG. 5B exemplarily illustrates that the respective second optical parts 320 have the same shape and size in a cross-section, but the invention is not limited thereto. In an alternative exemplary embodiment, at least one of the shapes of the second optical parts 320 may be different from the others. Also, at least one of the sizes of the shapes of the second optical parts 320 may be different from the others.

Referring back to FIGS. 1 and 5A, when the width of each of the first optical parts 310 is not constant along the third direction DR3, and an average value of the maximum and minimum widths of one of the first optical parts 310 may be greater than an average value of the maximum and minimum widths of one second optical part 320 adjacent to the first optical part 310. Also, referring to FIGS. 1 and 5A, when the width of each of the first optical parts 310 and the width of each of the second optical parts 320 are constant along the third direction DR3, any one of the first optical parts 310 may have greater width than that of the second optical part 320 adjacent thereto.

Referring back to FIGS. 1, 5A, and 5B, in a cross-section, the sum of the areas of the first optical parts 310 may be greater than that of the second optical parts 320. In a cross-section, when the sum of the areas of the first optical parts 310 is greater than that of the second optical parts 320, the transmission region in which the light provided from the backlight unit BLU is transmitted may be increased to be larger than the reflection region in which the light provided from the backlight unit BLU is reflected.

The thickness t1 of each of the first optical parts 310 may be the same as the thickness t2 of each of the second optical parts 320. However, the invention is not limited thereto, and the thickness of each of the first optical parts 310 may be different from the thickness t2 of each of the second optical parts 320.

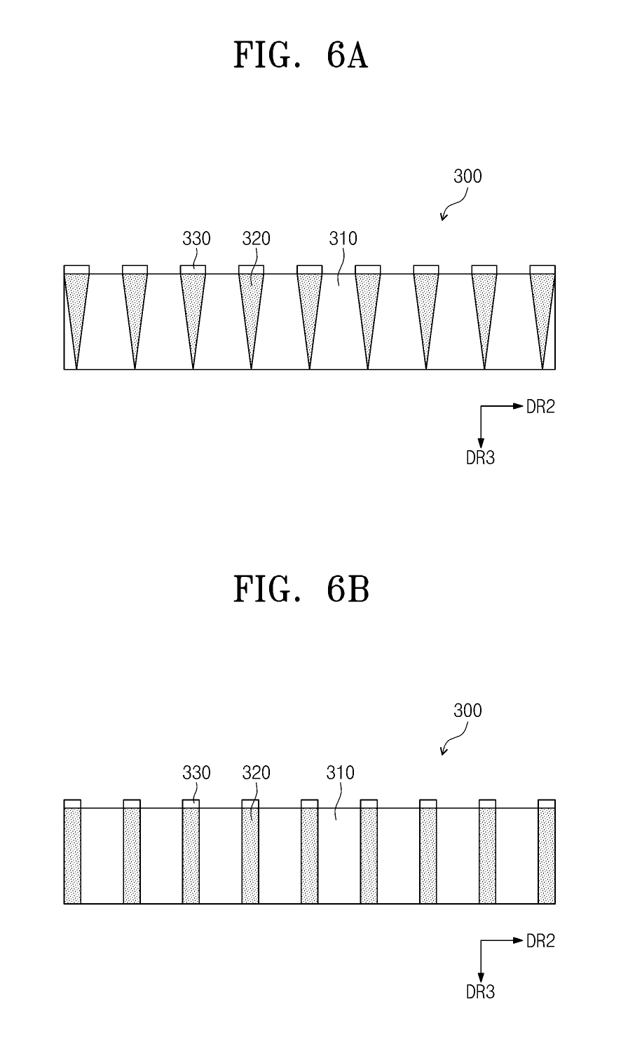

FIGS. 6A and 6B are schematic cross-sectional views of optical sheets included in photoluminescent display devices according to an exemplary embodiment of the invention.

Referring to FIGS. 6A and 6B, the optical sheet 300 may further include third optical parts 330. Each of the third optical parts 330 is provided on at least a portion of each of the second optical parts 320. Each of the third optical parts 330 may not overlap at least an upper surface of each of the first optical parts 310 in a plan view, but may overlap each of the second optical parts 320. FIGS. 6A and 6B exemplarily illustrate that one of the third optical parts fully overlaps one of the second optical parts 320, but the invention is not limited thereto. In an alternative exemplary embodiment, one of the third optical parts may partially overlap one of the second optical parts 320.

In an exemplary embodiment, each of the third optical parts 330 may have a rectangular shape in a cross-section. However, the invention is not limited thereto, and each of the third optical parts 330 may have various shapes such as triangular, square, circular, and elliptical shapes. Also, FIGS. 6A and 6B exemplarily illustrate that the respective third optical parts 330 have the same shape and size in a cross-section, but the invention is not limited thereto. In an alternative exemplary embodiment, at least one of the shapes of the third optical parts 330 may be different from the others.

The third optical parts 330 may have a third refractive index which is smaller than the second refractive index. The third refractive index may be the same as or different from the first refractive index. The third optical parts 330 may absorb, for example, at least a portion of the light which is not reflected from but transmitted through the second optical parts 320, and provide the display panel DP with the light.

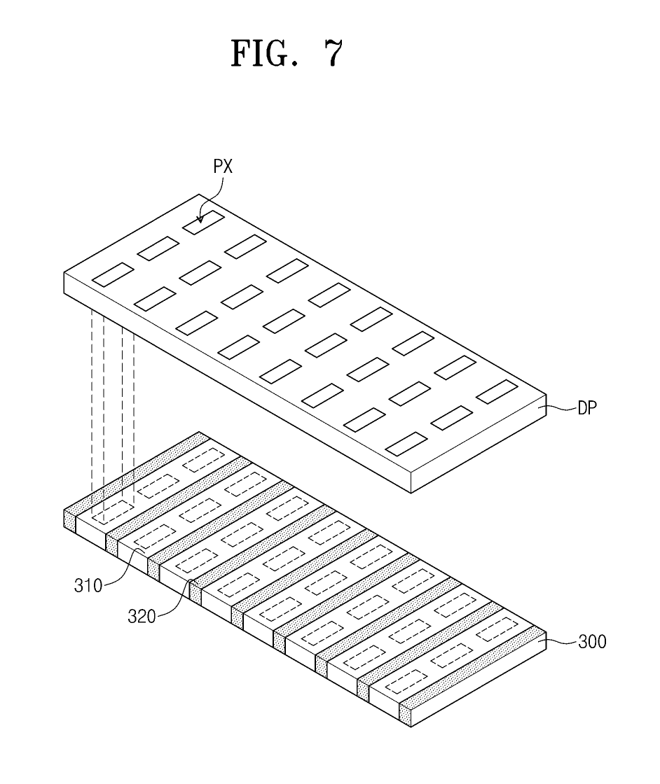

FIG. 7 is a schematic exploded perspective view illustrating a display panel and an optical sheet included in a photoluminescent display device according to an exemplary embodiment of the invention.

Referring to FIGS. 1, 3A, 3B, and 7, the display panel DP may further include a plurality of pixels PX. Each of the pixels PX may include a thin film transistor TFT (refer to FIG. 2), a first electrode EL1 (refer to FIG. 2), and a second electrode EL2 (refer to FIG. 2). Although not shown, each of the pixels PX may be connected to at least one gate line and at least one data line.

When viewed from the thickness direction DR3 of the display panel DP, the pixels PX may overlap the first optical parts 310. The pixels PX may overlap the first optical parts 310 and may receive a relatively greater amount of light compared to the case of overlapping the second optical parts 320. However, the invention is not limited thereto, and some of the pixels PX may overlap the second optical parts 320.

In a typical photoluminescent display device, a substantial amount of the light provided from the backlight unit leaks between the backlight unit and the display panel, and thus emission efficiency of the photoluminescent display device is disadvantageously decreased.

The photoluminescent display device according to an exemplary embodiment of the invention includes the optical sheet having the first and second optical parts 320 which have refractive indices different from each other, so that the light provided from the backlight unit may be collected and provided to the display panel. Accordingly, the amount of light leaking between the backlight unit and the display panel may be reduced, and the emission efficiency of the photoluminescent display device may be improved, thereby improving the display quality of the photoluminescent display.

A photoluminescent display device according to exemplary embodiments of the invention may have improved display quality.

The above-disclosed subject matter is to be considered illustrative and not restrictive, and the appended claims are intended to cover all such modifications, enhancements, and other exemplary embodiments, which fall within the true spirit and scope of the invention. Thus, to the maximum extent allowed by law, the scope of the invention is to be determined by the broadest permissible interpretation of the following claims and their equivalents, and shall not be restricted or limited by the foregoing detailed description. Therefore, the above-described exemplary embodiments are illustrative in all the exemplary embodiments, and should be construed as not being limitative.

What is claimed is:

1. A photoluminescent display device, comprising:
a backlight unit;
an optical sheet provided on the backlight unit; and
a display panel provided on the optical sheet,
wherein the display panel includes
a first substrate;
a first polarizing plate provided on the first substrate; and
a color conversion layer provided on the first polarizing plate and including a photoexcitation member, and
the optical sheet includes
a plurality of first optical parts each of which has a first refractive index; and
a plurality of second optical parts which are provided alternately with the plurality of first optical parts in a plan view, and each of which has a second refractive index greater than the first refractive index.

2. The photoluminescent display device of claim 1, wherein each of the plurality of first optical parts includes at least one of acryl-based resin, fluorine-based resin, silicon-based resin, polycarbonate-based resin, polyamide-based resin, polystyrene-based resin, polyvinylchloride-based resin, polyester-based resin, polyolefin-based resin, polyethylene-based resin, polypropylene-based resin, and polybutylene-based resin.

3. The photoluminescent display device of claim 1, wherein each of the plurality of second optical parts includes at least one of carbon black, iron oxide, chromium oxide, zirconium oxide, zinc or cerium oxide, manganese violet, blue ultramarine, chromium hydrate, and iron blue.

4. The photoluminescent display device of claim 1, wherein in the plan view, each of the plurality of first optical parts has at least one shape of rectangular, square, circular, and elliptical shapes.

5. The photoluminescent display device of claim 1, wherein in the plan view, the plurality of first optical parts extends in a first direction and is spaced apart from each other in a second direction crossing the first direction.

6. The photoluminescent display device of claim 5, wherein in the plan view, spacing distances between the plurality of first optical parts are constant.

7. The photoluminescent display device of claim 1, wherein in the plan view, the plurality of first optical parts is spaced apart from each other in a first direction and in a second direction crossing the first direction.

8. The photoluminescent display device of claim 1, wherein in a cross-section, a width of each of the plurality of first optical parts becomes greater as the plurality of first optical parts is closer to the backlight unit than to the display panel.

9. The photoluminescent display device of claim 1, wherein in a cross-section, a width of each of the plurality of first optical parts is constant.

10. The photoluminescent display device of claim 1, wherein in a cross section, a sum of areas of the plurality of first optical parts is greater than a sum of areas of the plurality of second optical parts.

11. The photoluminescent display device of claim 1, wherein in a cross-section, each of the plurality of first optical parts has a trapezoidal shape, and each of the plurality of second optical parts has an inverted triangular shape.

12. The photoluminescent display device of claim 1, wherein in a cross-section, each of the plurality of first and second optical parts has a rectangular shape.

13. The photoluminescent display device of claim 1, wherein a thickness of each of the plurality of first optical parts is the same as a thickness of each of the plurality of second optical parts.

14. The photoluminescent display device of claim 1, wherein the optical sheet further comprises third optical parts which are provided on at least a portion of the plurality of second optical parts, and each of which has a third refractive index smaller than the second refractive index.

15. The photoluminescent display device of claim 1, further comprising a reverse prism sheet provided between the backlight unit and the optical sheet.

16. The photoluminescent display device of claim 1, wherein the display panel further comprising a plurality of pixels,
the plurality of pixels overlapping the plurality of first optical parts.

17. The photoluminescent display device of claim 1, wherein the backlight unit emits blue light.
